(19) United States
(12) Patent Application Publication
(10) Pub. No.: US 2013/0136518 A1
(43) Pub. Date: May 30, 2013

(54) PRINTING CONTROL METHOD AND PRINTER

(71) Applicants: Chuntao Wang, Weihai (CN); Tianxin Jiang, Weihai (CN); Min Yang, Weihai (CN); Zhuanlong Yu, Weihai (CN); Jiabo Xu, Weihai (CN)

(72) Inventors: Chuntao Wang, Weihai (CN); Tianxin Jiang, Weihai (CN); Min Yang, Weihai (CN); Zhuanlong Yu, Weihai (CN); Jiabo Xu, Weihai (CN)

(73) Assignee: SHANDONG NEW BEIYANG INFORMATION TECHNOLOGY CO., LTD, Weihai (CN)

(21) Appl. No.: 13/814,894

(22) PCT Filed: Jul. 29, 2011
(86) PCT No.: PCT/CN11/77799

§ 371 Date: Feb. 7, 2013

(30) Foreign Application Priority Data
Aug. 10, 2010 (CN) 201010249401.2

(51) Int. Cl. B41J 29/393

(52) U.S. Cl. CPC B41J 29/393
USPC 400/74

(57) ABSTRACT

The disclosure provides a printing control method and a printer. The printing control method comprises: detecting the state of paper, and performing a mark process on printed receipt paper when the state of the paper is abnormal. With the disclosure, one or more problems caused by the abnormality of paper can be avoided.

### TECHNICAL FIELD OF THE INVENTION

The disclosure relates to a printing control method and a printer.

### BACKGROUND OF THE INVENTION

Receipt printer is widely used in fields such as lottery, transportation, supermarket and shopping mall to print securities or transaction documents, for example, lottery, ticket, purchase invoice and the like. These receipts can be used normally only when the face value content is printed completely.

During the printing process, if errors such as paper jam and paper absence occurs, the printer often stops printing, gives an alarm indication and waits an operator to clear the error. In this condition, unprinted data of the current receipt is missing due to the interruption of the printing operation, thus the receipt content printed is incomplete. The inventor finds that the printing problem caused by the abnormality of paper can not be effectively solved in related art, so that the receipt paper printed having a problem caused by the abnormality of the paper is difficultly recognized; therefore, the condition that lawbreakers use invalid receipt paper to pretend valid receipt paper or the receipt paper can not be normally used due to non-buyer's reason could happen, thus an unnecessary dispute is caused between a buyer and a seller.

### SUMMARY OF THE INVENTION

The disclosure is provided in view of the problem that the receipt paper printed having a problem caused by the abnormality of the paper is difficultly recognized in related art; therefore, the main purpose of the disclosure is to provide a printing control method and a printer to solve the above problem.

In order to realize the purpose above, a printing control method is provided according to one aspect of the disclosure. The printing control method comprises: detecting the state of a paper; and performing a mark process on a printed receipt paper when the state of the paper is abnormal.

Further, detecting the state of the paper comprises: detecting whether the paper is used up; and/or detecting whether the paper jammed in a paper conveying path; the abnormal state of the paper comprises that: the paper is used up; and/or the paper jammed in the paper conveying path.

Further, detecting whether the paper is used up comprises: detecting whether paper exists on upstream of a printing mechanism in the paper conveying path; detecting whether the paper jammed in the paper conveying path comprises: detecting whether the paper arrives at a first position of downstream of the printing mechanism in the paper conveying path within a first time; and/or detecting whether the paper leaves a second position of downstream of the printing mechanism in the paper conveying path within a second time.

Further, performing a mark process on the printed receipt paper comprises one or more of the following: printing identification on the printed receipt paper; performing hole punching on the printed receipt paper; and outputting first prompt information, wherein the first prompt information is used to indicate that the receipt paper is abnormal.

Further, printing identification on the printed receipt paper comprises: controlling the receipt paper to move along the reverse direction of a paper conveying path; and printing identification on the printed receipt paper.

In order to realize the purpose above, a printer is provided according to another aspect of the disclosure. The printer comprises: a paper house, which is configured to accommodate paper; a first printing mechanism, which is configured to print on the paper; a paper state detection mechanism, which is configured to detect whether the paper is abnormal; and a mark mechanism, which is configured to perform a mark process on printed receipt paper when the state of the paper is abnormal.

Further, the paper state detection mechanism comprises: a paper-out sensor, which is arranged in a paper conveying path and at upstream of the first printing mechanism to detect whether paper is absent; and/or a paper discharge sensor, which is arranged in the paper conveying path and at downstream of the first printing mechanism to detect whether paper jammed.

Further, the mark mechanism comprises one or more of the following: a second printing mechanism, which is configured to print identification information on the receipt paper; a punching mechanism, which is configured to perform hole punching on the receipt paper; and a first prompt mechanism, which is configured to output first prompt information, wherein the first prompt information is used to indicate that the receipt paper is abnormal.

Further, the first printing mechanism and the second printing mechanism are the same one printing mechanism.

Further, the printer also comprises: a second prompting mechanism, which is configured to output second prompt information, wherein the second prompt information is used to prompt a user to handle the error of the printer.

With the disclosure, the state of the paper is detected and the printed receipt paper is marked when the state of the paper is abnormal, so that the receipt paper obtained when the printing is abnormal has a processing mark and thus can be recognized easily; therefore, the problem that the receipt paper printed having a problem caused by the abnormality of the paper is difficultly recognized in related art is solved, and one or more problems caused by the abnormality of paper are prevented.

### BRIEF DESCRIPTION OF THE DRAWINGS

For a better understanding of the disclosure, accompanying drawings described hereinafter are provided to constitute one part of the application; the schematic embodiments of the disclosure and the description thereof are used to illustrate the disclosure but to limit the disclosure improperly. In the accompanying drawings:

FIG. 1 shows a diagram of a printer according to the embodiment of the disclosure;

FIG. 2 shows a flowchart of a printing control method according to the first embodiment of the disclosure; and

FIG. 3 shows a flowchart of a printing control method according to the second embodiment of the disclosure.

### DETAILED DESCRIPTION OF THE EMBODIMENTS

It should be noted that the embodiments in the application and the characteristics of the embodiments can be combined if no conflict is caused. The disclosure is described below in detail by reference to the accompanying drawings in conjunction with embodiments.

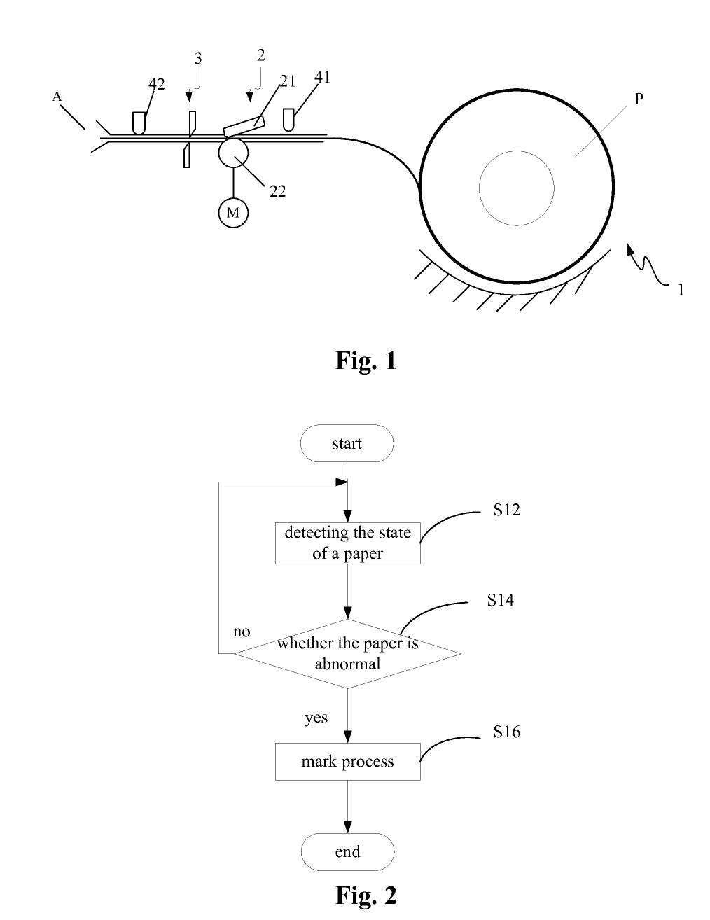

FIG. 1 shows a diagram of a printer according to the embodiment of the disclosure.

As shown in FIG. 1, the printer comprises a paper house 1, a printing mechanism 2, a cutter mechanism 3, a paper state detection mechanism and a mark mechanism, wherein the paper house 1 is configured to accommodate the paper used for printing, such as roll paper P; the printing mechanism 2 is located at downstream of the paper house in a paper conveying direction to print receipt information on the paper. For a convenient description, the paper printed with receipt information is called receipt paper; optionally, the cutter mechanism 3 is located at downstream of the printing mechanism 2 in the paper conveying direction to cut the printed receipt paper so that the printed receipt paper is separated from the roll paper; the paper state detection mechanism is located at a predetermined position of a paper conveying path of the printer and is electrically connected with a controller (not shown in the figure) of the printer to detect the state of the paper in the paper conveying path; the mark mechanism is configured to perform a mark process on the printed receipt paper when the state of the paper is abnormal.

With the printer above, in the condition that the paper is abnormal, the printed receipt paper is processed with mark, so that the receipt paper obtained when the printing is abnormal has a mark, thus the receipt paper printed when the paper is abnormal can be recognized conveniently; therefore, one or more problems caused by the abnormality of paper can be prevented effectively.

In order to make the paper conveyed in the paper conveying path, the printer above also can comprise a conveying mechanism, the conveying mechanism comprises a conveying roller and a driving motor M, wherein the conveying roller is located on the paper conveying path to convey the paper to move in the paper conveying path; the driving motor M is in transmission connection with the conveying roller and is electrically connected with the printer controller to provide to the conveying roller the power for conveying the paper.

Since the function of the printing mechanism 2 is to print receipt information including predetermined texts, images and the like on the paper P, how to implement the printing function would not impact the implementation of the disclosure; therefore, the printing mechanism 2 can be a thermal printing mechanism, a thermal transfer printing mechanism, a dot matrix printing mechanism, a inkjet printing mechanism and so on. In this embodiment, the printing mechanism 2 is a thermal printing mechanism, which comprises a printing head 21 and a roll 22, wherein the printing head 21 and the roller 22 are in tangent contact; and the paper P passes through between the printing head 21 and the roller 22. In this embodiment, the roller 22 is a conveying roller and is in transmission connection with the driving motor M. When printing is needed, the roller 22 drives paper to move in the paper outlet direction under the driving of the driving motor M; at the same time, the printing head 21 prints receipt information on the paper P. It should be noted that a dedicated conveying roller can be provided to convey the paper according to requirements in other embodiments of the disclosure.

In the embodiment of the disclosure, the mark mechanism can be the printing mechanism 2, and the printing mechanism 2 is configured to print predetermined identification on the printed receipt paper to realize the mark process, meanwhile, the mark mechanism also can be a punching mechanism or a prompt mechanism (not shown in the figure); in the condition of detecting the abnormal state of the paper, the punching mechanism can be configured to perform hole punching on the printed receipt paper or the prompt mechanism can be configured to output prompt information, wherein the prompt information is used to indicate that the printed receipt paper is abnormal. In this way, by marking identifications such as predetermined texts, images or holes on the receipt paper through the mark mechanism, the receipt paper printed when the paper is abnormal can be recognized conveniently, the buyer or issuer of the receipt paper can perform corresponding following processes according to the identification, for example, invalidating the receipt paper, reprinting the receipt paper or allowing the use of the receipt paper.

As shown in FIG. 1, the paper state detection mechanism comprises a paper-out sensor 41 and a paper discharge sensor 42, wherein the paper-out sensor 41 is arranged at a predetermined position of upstream of the printing mechanism in the paper conveying path along the paper conveying direction to detect whether paper exists or paper is absent in the paper conveying path during the printing process; the paper discharge sensor 42 is arranged at a predetermined position of upstream of a paper outlet A of the printer to detect the running state of the paper. It should be noted that, in the embodiment of the disclosure, one of the paper-out sensor 41 and the paper discharge sensor 42 can be arranged according to requirements, or both of them can be arranged.

It should be noted that the paper discharge sensor can judge whether paper jammed through the following methods:

detecting whether the paper arrives at a first position of downstream of the printing mechanism in the paper conveying path within a first time, wherein if the paper does not arrive at the first position of downstream of the printing mechanism in the paper conveying path within the first time, it is judged that paper jam occurs; and/or

detecting whether the paper leaves a second position of downstream of the printing mechanism in the paper conveying path within a second time, wherein if the paper does not leave the second position of downstream of the printing mechanism in the paper conveying path within the second time, it is judged that paper jam occurs.

Wherein the first position and the second position can be the same position or different positions. When the first position and the second position are different, two paper discharge sensors needed to be arranged. In some printers, the length of the receipt paper is fixed and the above two detections can be performed simultaneously; while in some printers, the length of the receipt paper is not fixed, thus the time the paper leaves the second position of downstream of the printing mechanism in the paper conveying path might change, at this moment, preferably, it is only needed to detect whether the paper arrives at the first position of downstream of the printing mechanism in the paper conveying path within the first time, thus no impact is caused by the length of the receipt paper.

FIG. 2 shows a flowchart of a printing control method according to the first embodiment of the disclosure. The printing control method comprises the following steps:

Step 12: detecting the state of paper.

The paper state detection mechanism feeds back a paper state signal to a printer controller in real time; then the controller can learn the state of the paper in the printer through the state signal fed back by the paper state detection mechanism.

Step 14: judging whether the state of the paper is abnormal, if yes, executing Step 16; otherwise, executing Step 12 to continue detecting the state of the paper.

The paper-out sensor and the paper discharge sensor of the paper state detection mechanism output different electric signals when detecting that paper exists or paper is absent. The controller judges whether the state of the paper is abnormal according to the electric signal output from the sensor.

The paper-out sensor and the paper discharge sensor can be photoelectric sensors or mechanical sensors; hereinafter, the working principle of the paper state detection mechanism is illustrated by taking the paper-out sensor as an example.

When the paper-out sensor is a reflective photoelectric sensor, in the condition that paper exists, the paper covers the surface of the sensor, then a receiving tube of the photoelectric sensor receives the light reflected from the paper surface emitted by a luminous tube; therefore, the output voltage of the sensor is low level; in the condition that paper is absent, there is no paper covered the surface of the sensor, then the receiving tube of the photoelectric sensor can not receive the light reflected from the paper; therefore, the output voltage of the sensor is high level. During the printing process, if the paper-out sensor sends a low level to the controller, it is indicated that paper exists is detected; therefore, the state of the paper is normal; if the paper-out sensor sends a high level to the controller, it is indicated that paper is absent is detected, that is, the paper is used up; therefore, the state of the paper is abnormal. Similarly, for the paper discharge sensor, the electric signal output is different when paper exists or paper is absent. When the printing starts, during the first predetermined time in which the paper should reach the paper discharge sensor, if the paper discharge sensor does not detect that paper exists, or, during the second predetermined time in which the paper should leave the paper discharge sensor, if the paper discharge sensor still can detect that paper exists, it is indicated that the paper jammed in the path, that is, the state of the paper is abnormal; otherwise, the state of the paper is normal. The controller judges whether the state of the paper is abnormal according to the signal fed back by the paper-out sensor or the paper discharge sensor.

Step 16: performing mark process.

When the controller judges that the state of the paper is abnormal, a dedicated mark mechanism can be set to perform the mark process, or an existing printing mechanism can be applied to printing identification on the paper to perform the mark process; at this moment, the conveying mechanism is controlled to drive the receipt paper to move along the reverse direction of the paper conveying direction, so as to return the receipt paper to the printing mechanism; then the printing mechanism performs mark process on the current receipt paper which is printed incompletely. The specific method can comprise: the printing mechanism prints on the receipt paper texts or images indicating that the receipt paper can not be used, for example word sample “invalidation”, to prevent the printed incomplete receipt paper from being used by lawbreakers. Or, the printing mechanism prints on the receipt paper the reason for the abnormality of the receipt paper, for example “Paper Absence Error” or “Paper Jam Error”; this identification can be used as the certification of the following special process for the receipt paper.

During the printing process, the printing control method provided in the embodiment of the disclosure performs a mark process on the receipt paper which has a printing abnormality (for example, incompletely printing) through the printing mechanism when the state of the paper is abnormal, thereby distinguishing the validity of the receipt paper and avoiding the circulation of invalid receipt paper.

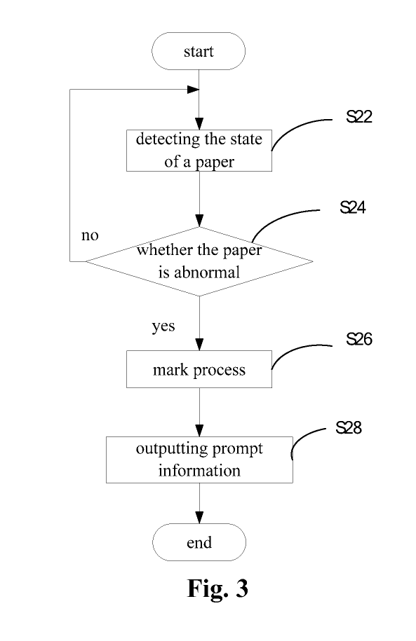

FIG. 3 shows a flowchart of a printing control method according to the second embodiment of the disclosure. The method comprises the following steps:

Step 22 to Step 26 is the same as Step 12 to Step 16.

Step 28: outputting prompt information.

Depending on the abnormality type of the state of the paper, receipt paper is printed out or prompt information is sent out. When the abnormal state of the paper is that the paper jammed, the controller controls a prompt mechanism (for example, buzzer, indicator or display) of the printer to send out prompt information, so that a printer operator can eliminate the paper jam error in time. When the abnormal state of the paper is that the paper is used up, after the mark process, the controller controls the conveying mechanism to discharge the receipt paper printed with a mark out of the printer via a paper outlet, and indicates the prompt mechanism of the printer to send out prompt information to prompt the operator to change the paper in time.

During the printing process, the printing control method provided in the embodiment of the disclosure performs a mark process on the incompletely printed receipt paper through the printing mechanism when the state of the paper is abnormal, thereby distinguishing the validity of the receipt paper and avoiding the circulation of invalid receipt paper. Further, the method above can further comprise sending out prompt information through the prompt mechanism of the printer to prompt the operator to eliminate error in time.

From the description above, it can be seen that the embodiment of the disclosure can effectively prevent one or more problems caused by the abnormality of paper by performing a mark process on the printed receipt paper when the paper is abnormal.

The above are only the preferred embodiments of the disclosure and not intended to limit the disclosure. For those skilled in the art, various modifications and changes can be made to the disclosure. Any modification, equivalent substitute and improvement made within the spirit and principle of the disclosure are deemed to be comprised within the scope of protection of the disclosure.

1. A printing control method, comprising:
detecting the state of a paper; and
performing a mark process on a printed receipt paper when the state of the paper is abnormal.

2. The printing control method according to claim 1,
wherein detecting the state of the paper comprises:
detecting whether the paper is used up; and/or
detecting whether the paper jammed in a paper conveying path,
wherein the abnormal state of the paper comprises:
the paper is used up; and/or
the paper jammed in the paper conveying path.

3. The printing control method according to claim 2,
wherein detecting whether the paper is used up comprises:
detecting whether paper exists on upstream of a printing mechanism in the paper conveying path;
wherein detecting whether the paper jammed in the paper conveying path comprises:
detecting whether the paper arrives at a first position of downstream of the printing mechanism in the paper conveying path within a first time; and/or
detecting whether the paper leaves a second position of downstream of the printing mechanism in the paper conveying path within a second time.

4. The printing control method according to claim 1, wherein performing a mark process on the printed receipt paper comprises one or more of the following:
printing identification on the printed receipt paper;
performing hole punching on the printed receipt paper; and
outputting first prompt information, wherein the first prompt information is configured to indicate that the receipt paper is abnormal.

5. The printing control method according to claim 4, wherein printing identification on the printed receipt paper comprises:
controlling the receipt paper to move along the reverse direction of a paper conveying path; and
printing identification on the receipt paper.

6. A printer, comprising:
a paper house configured to accommodate paper;
a first printing mechanism configured to print on the paper;
a paper state detection mechanism configured to detect whether the paper is abnormal; and
a mark mechanism configured to perform a mark process on printed receipt paper when the state of the paper is abnormal.

7. The printer according to claim 6, wherein the paper state detection mechanism comprises:
a paper-out sensor arranged in a paper conveying path and at upstream of the first printing mechanism to detect whether paper is absent; and/or
a paper discharge sensor arranged in the paper conveying path and at downstream of the first printing mechanism to detect whether paper jammed.

8. The printer according to claim 6, wherein the mark mechanism comprises one or more of the following:
a second printing mechanism configured to print identification information on the receipt paper;
a punching mechanism configured to perform hole punching on the receipt paper; and
a first prompt mechanism configured to output first prompt information, wherein the first prompt information is used to indicate that the receipt paper is abnormal.

9. The printer according to claim 8, wherein the first printing mechanism and the second printing mechanism are the same one printing mechanism.

10. The printer according to claim 6, further comprising:
a second prompting mechanism configured to output second prompt information, wherein the second prompt information is used to prompt a user to handle the error of the printer.

11. The printer according to a claim 7, further comprising:
a second prompting mechanism configured to output second prompt information, wherein the second prompt information is used to prompt a user to handle the error of the printer.

12. The printer according to a claim 8, further comprising:
a second prompting mechanism configured to output second prompt information, wherein the second prompt information is used to prompt a user to handle the error of the printer.

13. The printer according to a claim 9, further comprising:
a second prompting mechanism configured to output second prompt information, wherein the second prompt information is used to prompt a user to handle the error of the printer.
